(19) United States
(12) Patent Application Publication
(10) Pub. No.: US 2025/0142320 A1
(43) Pub. Date: May 1, 2025

(54) METHOD AND APPARATUS FOR DETERMINING RELAY UE FOR CONSTRAINED UE

(71) Applicant: Samsung Electronics Co., Ltd., Suwon-si, Gyeonggi-do (KR)

(72) Inventors: Sapan Pramodkumar SHAH, Bangalore (IN); Basavaraj Jayawant PATTAN, Bangalore (IN)

(21) Appl. No.: 18/834,429

(22) PCT Filed: Feb. 8, 2023
(86) PCT No.: PCT/KR2023/001860

§ 371 Date: Jul. 30, 2024

(30) Foreign Application Priority Data
Feb. 8, 2022 (IN) 202241006790
Dec. 30, 2022 (IN) 2022 41006790

(51) Int. Cl. H04W 8/22; H04L 47/36; H04W 60/04

(52) U.S. Cl. CPC H04W 8/22; H04L 47/36; H04W 60/04

(57) ABSTRACT

The disclosure relates to a 5G or 6G communication system for supporting a higher data transmission rate. According to an embodiment, a method performed by a first user equipment (UE) which is a constrained UE in a wireless communication system is provided. The method comprises transmitting, to a plurality of UEs, a first message for requesting a relay configuration for the first UE, receiving, from at least one UE with a relay capability among the plurality of UEs, a second message as a response to the first message, the second message comprising information on the relay configuration, and identifying a second UE for a relay service among the at least one UE with the relay capability based on the information on a maximum allowed packet size of the second UE.

### TECHNICAL FIELD

The present disclosure relates to an wireless communication, and more specifically to a method and a system for determining a relay User Equipment (UE) for a constrained UE.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

According to an embodiment, a method performed by a first user equipment (UE) which is a constrained UE in a wireless communication system is provided. The method comprises transmitting, to a plurality of UEs, a first message for requesting a relay configuration for the first UE, receiving, from at least one UE with a relay capability among the plurality of UEs, a second message as a response to the first message, the second message comprising information on the relay configuration, and identifying a second UE for a relay service among the at least one UE with the relay capability based on the information on a maximum allowed packet size of the second UE.

According to an embodiment, a first user equipment (UE) which is a constrained UE in a wireless communication system is provided. The first UE comprises a transceiver and a controller coupled with the transceiver and configured to transmit, to a plurality of UEs, a first message for requesting a relay configuration for the first UE, receive, from at least one UE with a relay capability among the plurality of UEs, a second message as a response to the first message, the second message comprising information on the relay configuration, and identify a second UE for a relay service among the at least one UE with the relay capability based on the information on a maximum allowed packet size of the second UE.

According to an embodiment, a method performed by a second user equipment (UE) with a relay capability in a wireless communication system is provided. The method comprises receiving, from a first UE which is a constrained UE, a first message for requesting a relay configuration for the first UE, and transmitting, to the first UE, a second message as a response to the first message, the second message comprising information on the relay configuration. The second UE with the relay capability is used for a relay service based on the information on a maximum allowed packet size of the second UE comprised in the second message.

According to an embodiment, a second user equipment (UE) with a relay capability in a wireless communication system is provided. The second UE comprises a transceiver and a controller coupled with the transceiver and configured to receive, from a first UE which is a constrained UE, a first message for requesting a relay configuration for the first UE, and transmit, to the first UE, a second message as a response to the first message, the second message comprising information on the relay configuration. The second UE with the relay capability is used for a relay service based on the information on a maximum allowed packet size of the second UE comprised in the second message.

### BRIEF DESCRIPTION OF DRAWINGS

This method and apparatus are illustrated in the accompanying drawings, throughout which like reference letters indicate corresponding parts in the various figures. The embodiments herein will be better understood from the following description with reference to the drawings, in which:

FIG. 1 is a block diagram of a system for determining a relay UE for a constrained UE according to an embodiment;

FIG. 2A is a diagram illustrating a method for determining the relay UE for the constrained UE according to an embodiment;

FIG. 2B is a diagram illustrating a method for determining the relay UE for the constrained UE according to an embodiment;

FIG. 3 is a diagram illustrating signaling between the constrained UE and the relay UEs for selecting an appropriate relay UE according to an embodiment;

FIG. 4 is a diagram illustrating signaling of the constrained UE with the selected relay UE for registering to use relay capability of the selected relay UE according to an embodiment;

FIG. 5 illustrates a structure of a UE according to an embodiment of the disclosure; and

FIG. 6 illustrates a structure of a base station according to an embodiment of the disclosure.

### BEST MODE FOR CARRYING OUT THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide a method for determining a relay User Equipment (UE) for a constrained UE. The method includes sending, by the constrained UE, a relay configuration request message to a plurality of UEs. The method includes receiving, by the constrained UE, a relay configuration response message from at least one UE supporting a relay service in the plurality of UEs. The method includes determining, by the constrained UE, a maximum allowed packet size of the at least one UE based on the relay configuration response message. The method includes determining, by the constrained UE, the relay UE in the at least one UE for using the relay service of the relay UE based on the maximum allowed packet size of the at least one UE.

Accordingly, the embodiments herein provide a constrained UE for determining the relay UE. The constrained UE includes a relay controller, a memory, a processor, where the relay controller is coupled to the memory and the processor. The relay controller is configured for sending the relay configuration request message to the plurality of UEs. The relay controller is configured for receiving the relay configuration response message from the at least one UE supporting the relay service in the plurality of UEs. The relay controller is configured for determining the maximum allowed packet size of the at least one UE based on the relay configuration response message. The relay controller is configured for determining the relay UE in the at least one UE for using the relay service of the relay UE based on the maximum allowed packet size of the at least one UE.

Accordingly, the embodiments herein provide a method for determining the relay UE for the constrained UE. The method includes receiving, by a UE, a relay configuration request message from the constrained UE. The method includes determining, by the UE, whether the UE has a capability to provide the relay service to the constrained UE. The method includes sending, by the UE, the relay configuration response message to the constrained UE.

Accordingly, the embodiments herein provide the UE for determining the relay UE for the constrained UE. The UE includes a relay controller, a memory, a processor, where the relay controller is coupled to the memory and the processor. The relay controller is configured for determining whether the UE has the capability to provide the relay service to the constrained UE. The relay controller is configured for sending the relay configuration response message to the constrained UE.

The constrained UE requests for configuration from nearby non-constrained UEs with relay capabilities. Further, the constrained UE receives a configuration (i.e. maximum allowed packet size and other parameters of the relay UE) from the all possible non-constrained UEs with the relay capabilities. Further, the constrained device selects an appropriate non-constrained UE based on supported maximum packet size and other parameters of the relay UE, and possibly adjusts its own maximum allowed packet size based on the received configuration. Moreover, the constrained UE encodes messages to request for the relay UE configuration, to response for the relay UE configuration, to request and register at the relay UE and to response for the registration at the relay UE.

Existing methods and systems allow the constrained UE to select any available non-constrained UE as a relay UE without knowing its configuration, which may affect a MSGin5G service as sending messages from the constrained UE may fail to reach at a MSGin5G server or delayed to reach at the MSGin5G server due to segmentation and assembly procedure. Unlike the existing methods and systems, the proposed method allows the constrained UE to select the appropriate non-constrained UE to use as the relay UE, and register itself with the selected non-constrained UE to use a relay service providing by the non-constrained UE. Thus, the constrained UE can connect and send the data to a MSGin5G server via the selected relay UE without any failure or the segmentation and assembly procedure delay in the data transmission even a direct connection of the constrained UE with the MSGin5G server is unavailable or the constrained UE are moved to an out of coverage zone, which improves the end user experience and service satisfaction.

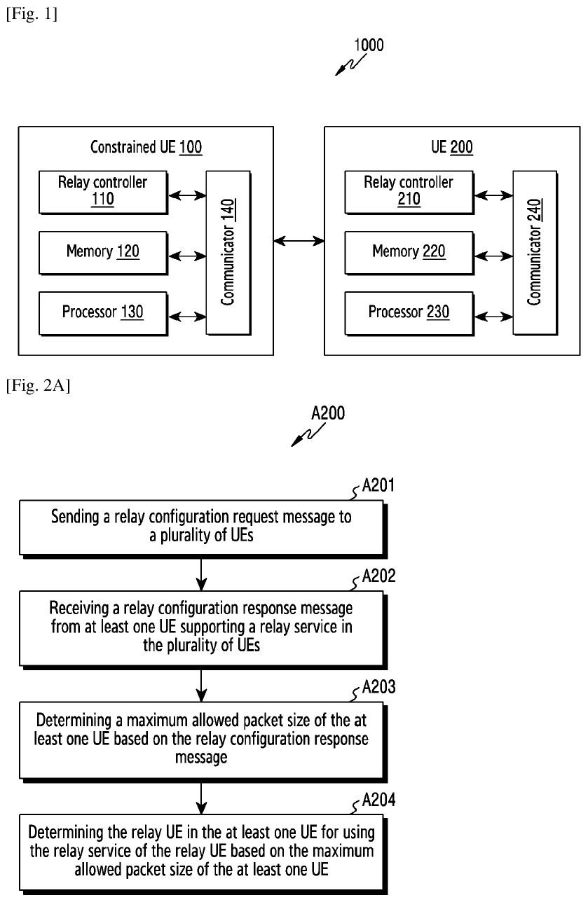

Referring now to the drawings, and more particularly to FIGS. 1 through 6, there are shown preferred embodiments.

Massive Internet of Things (MIoT) UEs are one of key market segments of Fifth Generation (5G) cellular system. Third Generation Partnership Project (3GPP) is currently defining a message service in 5G cellular system called as MSGin5G service. The MSGin5G service is basically designed and optimized for MIoT UE communication including thing-to-thing communication and person-to-thing communication. The MSGin5G service enables various message communication models with advanced service capabilities and performance.

Existing application architecture enables deployment of the MSGin5G service in the MIoT UEs including constrained devices (e.g. sensors, actuators) and unconstrained devices with advanced capabilities (e.g. washing machine, micro-ovens). Also, the MIoT UEs may or may not have a USIM, and the constrained devices are constrained in resources, i.e. limited storage or computation resource.

There is a use case where a MSGin5G UE (i.e. MIoT UE supporting the MSGin5G service) may not have direct connection with a MSGin5G server as the MSGin5G UE is the constrained device with limitation in connecting to the MSGin5G server or the MSGin5G UE moved to an out of coverage zone and do not have direct connect with the MSGin5G server. Few existing methods consider this type of MSGin5G UE as a constrained device. In such case, the constrained device uses another MSGin5G UE having a relay capability to provide connection to the MSGin5G server.

Further, each MSGin5G UE is configured with a maximum allowed packet size that it can transport. If the data received from the constrained device to send by the relay UE (i.e. MSGin5G UE having the relay capability) is more than the allowed packet size of the relay UE, then a MSGin5G client on the relay UE performs segmentation of the received data and then send each data segment to a receiver UE, and further a MSGin5G client on the receiver UE assembles all data segments to form a single packet, which may leads to failure in data transmission or delayed data transmission due to segmentation and assembly procedure. In order to provide better service experience for MSGin5G user/application, an appropriate selection of the relay UE is required among possible multiple relay UEs.

The principal object of the embodiments herein is to provide a method and a system for constrained UEs to select an appropriate non-constrained UE to use as a relay UE, and register itself with the selected non-constrained UE to use a relay service providing by the non-constrained UE. Thus, the constrained UE can connect and send the data to a MSGin5G server via the selected relay UE without any failure or segmentation and assembly procedure delay in data transmission even a direct connection of the constrained UEs with the MSGin5G server is unavailable or the constrained UEs are moved to an out of coverage zone, which improves the end user experience and service satisfaction.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

FIG. 1 is a block diagram of a system (1000) for determining a relay UE for a constrained UE (100) according to an embodiment.

Referring to FIG. 1, In an embodiment, the system (1000) comprises the constrained UE (100) and a plurality of UEs. The constrained UE (100) is a MSGin5G UE with constrained resources, i.e. limited storage or computation resource. Examples of the constrained UE (100) include, but are not limited to sensors, actuators, etc. The plurality of UEs comprises unconstrained MSGin5G UEs (herein called as UEs (200)) with relay capability and able to provide a relay service to the constrained UE (100). Examples of the plurality of UEs include, but are not limited to a smartphone, a tablet computer, a Personal Digital Assistance (PDA), a desktop computer, an Internet of Things (IoT) (e.g. washing machine, micro-ovens), a wearable device, etc.

In an embodiment, the constrained UE (100) includes a relay controller (110), a memory (120), a processor (130), and a communicator (140). The relay controller (110) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The relay controller (110) sends a relay configuration request message to a plurality of UEs. Further, the relay controller (110) receives a relay configuration response message from the UEs (200) supporting the relay service in the plurality of UEs. Further, the relay controller (110) determines the maximum allowed packet size of the UE (200) based on the relay configuration response message. Further, the relay controller (110) determines the relay UE in the UEs (200) for using the relay service of the relay UE based on the maximum allowed packet size of the UEs (200). In an embodiment, the relay configuration request message includes a Layer-2 identity, a UE service identifier, a MSGin5G device identifier, and a maximum allowed packet size of the constrained UE (100). In an embodiment, the relay configuration response message includes a Layer-2 identity, a UE service identifier, a MSGin5G device identifier, and a maximum allowed packet size of the UEs (200).

In an embodiment, for determining the relay UE in the UEs (200) for using the relay service of the relay UE based on the maximum allowed packet size of the UEs (200), the relay controller (110) determines whether the maximum allowed packet size of the UEs (200) is equal or more than a maximum allowed packet size of the constrained UE (100). The relay controller (110) selects the relay UE whose the maximum allowed packet size of the relay UE is equal or more than the maximum allowed packet size of the constrained UE (100) among the UEs (200), when the maximum allowed packet size of the UEs (200) is equal or more than the maximum allowed packet size of the constrained UE (100). The relay controller (110) selects the relay UE in the UEs (200) with a largest maximum allowed packet size, when the maximum allowed packet size of the UEs (200) is less than the maximum allowed packet size of the constrained UE (100). Further, the relay controller (110) modifies the maximum allowed packet size of the constrained UE (100) to the largest maximum allowed packet size of the selected relay UE.

In an embodiment, the relay controller (110) further sends a registration request message to the selected relay UE to register for consuming the relay service of the relay UE. Further, the relay controller (110) receives a registration response message with a status of registration of the constrained UE (100) from the relay UE. Further, the relay controller (110) determines whether the constrained UE (100) is registered at the relay UE based on the status of registration, and accesses the relay service of the relay UE upon successful registration. In an embodiment, the registration request message includes a UE service identifier, and a MSGin5G UE ID of the constrained UE (100), and a time till the constrained UE (100) is intended to use the relay service from the relay UE. In an embodiment, the registration response message includes a time till the constrained UE (100) is allowed to use the relay service from the relay UE.

The memory (120) stores information of the layer-2 identity, the UE service identifier, the MSGin5G device identifier, and the maximum allowed packet size of the relay UEs (200) in the relay configuration response message. The memory (120) stores instructions to be executed by the processor (130). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information than its storage space. In certain examples, a non-transitory storage medium may store data that can, over time, change (e.g., in Random Access Memory (RAM) or cache). The memory (120) can be an internal storage unit or it can be an external storage unit of the constrained UE (100), a cloud storage, or any other type of external storage.

The processor (130) is configured to execute instructions stored in the memory (120). The processor (130) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (130) may include multiple cores to execute the instructions. The communicator (140) is configured for communicating internally between hardware components in the constrained UE (100). Further, the communicator (140) is configured to facilitate the communication between the constrained UE (100) and other devices via one or more networks (e.g. Radio technology). The communicator (140) includes an electronic circuit specific to a standard that enables wired or wireless communication.

In an embodiment, each UE (200) includes a relay controller (210), a memory (220), a processor (230), and a communicator (240). The relay controller (210) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The relay controller (210) determines whether the UEs (200) has the capability to provide the relay service to the constrained UE. The relay controller (210) sends the relay configuration response message to the constrained UE. The relay controller (210) receives the registration request message from the constrained UE (100). The relay controller (210) determines whether the constrained UE (100) is authorized to consume the relay service. The relay controller (210) sends the registration response message with the status of registration of the constrained UE (100) to the constrained UE (100).

The memory (220) stores the information of the layer-2 identity, the UE service identifier, the MSGin5G device identifier, and the maximum allowed packet size of the constrained UE (100) in the relay configuration request message. The memory (220) stores instructions to be executed by the processor (230). The memory (220) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (220) may, in some examples, be considered a non-transitory storage medium. The term “non-transitory” may indicate that the storage medium is not embodied in a carrier wave or a propagated signal. However, the term “non-transitory” should not be interpreted that the memory (220) is non-movable. In some examples, the memory (220) can be configured to store larger amounts of information than its storage space. In certain examples, a non-transitory storage medium may store data that can, over time, change (e.g., in Random Access Memory (RAM) or cache). The memory (220) can be an internal storage unit or it can be an external storage unit of the relay UEs (200), a cloud storage, or any other type of external storage.

The processor (230) is configured to execute instructions stored in the memory (220). The processor (230) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (230) may include multiple cores to execute the instructions. The communicator (240) is configured for communicating internally between hardware components in the relay UEs (200). Further, the communicator (240) is configured to facilitate the communication between the relay UEs (200) and other devices via one or more networks (e.g. Radio technology). The communicator (240) includes an electronic circuit specific to a standard that enables wired or wireless communication.

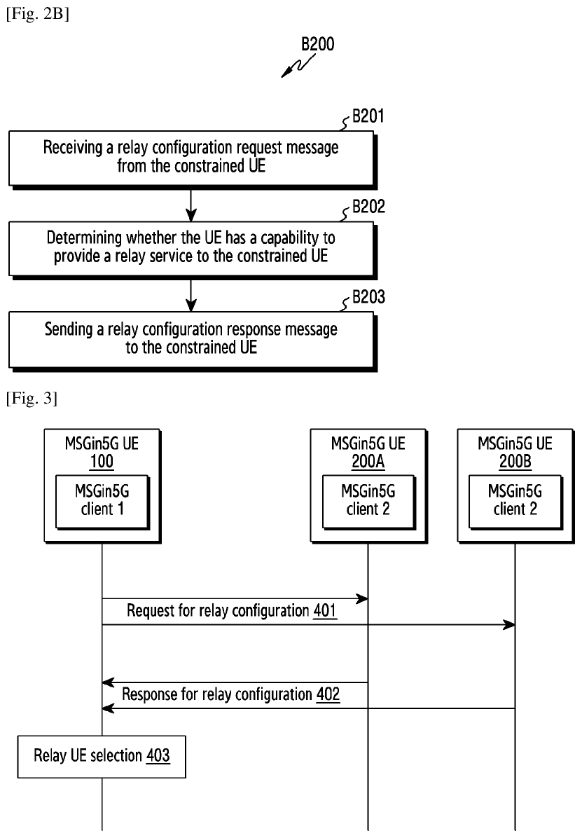

Although the FIG. 1 shows the hardware components of the system (1000) but it is to be understood that other embodiments are not limited thereon. In other embodiments, the system (1000) may include less or a greater number of components. Further, the labels or names of the components are used only for illustrative purpose and does not limit the scope of the invention. One or more components can be combined together to perform same or substantially similar function for determining the relay UE for the constrained UE (100). For example, the constrained UE (100) includes a processor (or, controller) including the relay controller (110) and the processor (130), and the processor is configured to perform operations of the relay controller (100) and the processor (130). That is, a processor included in the constrained UE (100) is configured to perform steps A201 to A204 illustrated in FIG. 2A. For example, the UE (200) includes a processor (or, controller) including relay controller (210) and the processor (230), and the processor is configured to perform operations of the relay controller (210) and the processor (230). That is, a processor included in the UE (200) is configured to perform steps B201 to B203 illustrated in FIG. 2B.

FIG. 2A is a diagram (A200) illustrating a method for determining the relay UE for the constrained UE (100) according to an embodiment.

Referring to FIG. 2A, according to an embodiment, the method allows the relay controller (110) to perform steps A201-A204 of the flow diagram (A200). Another example, a controller or a processor included in the constrained UE (100) is configured to perform steps A201-A204.

At step A201, the method includes sending the relay configuration request message to the plurality of UEs. At step A202, the method includes receiving the relay configuration response message from the UEs (200) supporting the relay service in the plurality of UEs. At step A203, the method includes determining the maximum allowed packet size of the UEs (200) based on the relay configuration response message. At step A204, the method includes determining the relay UE in the UEs (200) for using the relay service of the relay UE based on the maximum allowed packet size of the UEs (200).

FIG. 2B is a diagram (B200) illustrating a method for determining the relay UE for the constrained UE (100) according to an embodiment.

Referring to FIG. 2B, according to an embodiment, the method allows the relay controller (210) to perform steps B201-B203 of the flow diagram (B200). Another example, a controller and a processor included in the UE (200) is configured to perform steps B201-B203.

At step B201, the method includes receiving the relay configuration request message from the constrained UE (100). At step B202, the method includes determining whether the UE (200) has the capability to provide the relay service to the constrained UE (100). At step B203, the method includes sending the relay configuration response message to the constrained UE (100).

The various actions, acts, blocks, steps, or the like in the flow diagrams (A200, B200) may be performed in the order presented, in a different order, or simultaneously. Further, in some embodiments, some of the actions, acts, blocks, steps, or the like may be omitted, added, modified, skipped, or the like without departing from the scope of the invention.

FIG. 3 is a diagram illustrating signaling between the constrained UE (100) and the relay UEs for selecting the appropriate relay UE according to an embodiment.

Referring to FIG. 3, signaling flow for a MSGin5G client 1 in the MSGin5G UE (100) (which is the constrained UE) to request other MSGin5G UEs (200A, 200B) (i.e. relay UEs) having relay service capabilities to provide their configuration is illustrated.

The MSGin5G client 1 in MSGin5G UE (100) (which is the constrained UE) broadcasts (401) the message (i.e. relay configuration request message) to all surrounding MSGin5G UEs (200A, 200B) to obtain the relay configuration of the MSGin5G UEs (200A, 200B) if relay service is supported by the MSGin5G UEs (200A, 200B). The relay configuration request message includes information elements as specified in table 1.

TABLE 1
Information elements in relay configuration request message

| Information | | |
|---|---|---|
| element | Status | Description |
| Layer-2 ID | M | Layer-2 identity of UE-2 |
| UE service | M | UE service identifier of the |
| ID | | UE-2 |
| MSGin5G | O | MSGin5G device identifier |
| UE ID | | of the UE-2 |
| Expected | O | Maximum allowed packet |
| packet size | | size of the UE-2 |

Upon receiving the request from the MSGin5G client 1 of the MSGin5G UE (100), the MSGin5G client 2 of the MSGin5G UEs (200A, 200B) checks whether the MSGin5G UEs (200A, 200B) supports the relay service capability or not. If the MSGin5G UEs (200A, 200B) supports the relay service capability, the MSGin5G client 2 sends a response (402) for the relay configuration, i.e. relay configuration response message. The response message includes information elements as specified in table 2.

TABLE 2
Information elements in relay configuration response message

| Information | | |
|---|---|---|
| element | Status | Description |
| Layer-2 ID | M | Layer-2 identity of UE-1 |
| UE service | M | UE service identifier of the |
| ID | | UE-1 |
| MSGin5G | O | MSGin5G device identifier |
| UE ID | | of the UE-1 |
| Supported | M | Maximum allowed packet |
| packet size | | size of the UE-1 |

Table 2: Information elements in relay configuration response message

Table 2: Information elements in relay configuration response message

The MSGin5G client 2 sends response even if the expected packet size is more than the supported packet size. This allows the MSGin5G client 1 to select appropriate relay UE especially when none of the relay UEs supports the expected packet size.

If the MSGin5G UE (100) receives the responses from the multiple different relay UEs (i.e. MSGin5G UE (200A) with support for the relay service), then the MSGin5G client 1 of the MSGin5G UE (100) selects (403) the relay UE whose value of the supported packet size is equal or more than the value of the expected packet size of the MSGin5G UE (100). If value of the supported packet size is less than the value of the expected packet size for all relay UEs, then the MSGin5G client 1 of the MSGin5G UE (100) selects the relay UE with the maximum value of the supported packet size among all relay UEs and further sets the maximum allowed packet size of the own UE (i.e. MSGin5G UE (100)) to the value of the supported packet size of the selected relay UE.

In an embodiment, the MSGin5G client 1 includes one or more other parameters (e.g. expected battery level, availability duration, etc.) in the request for the relay configuration to select the relay UE. In an embodiment, the MSGin5G client 2 includes one or more other parameters (e.g. current battery level, availability duration, etc.) in the response.

In an embodiment, the MSGin5G client 1 includes an expected variance on a lower side of expected parameters in the request for the relay configuration to indicate the MSGin5G UE (200A, 200B) about the expected variance on a lower side of supported parameters which can be considered by the MSGin5G client 1 while selecting the relay UE.

In an embodiment, the MSGin5G client 1 selects any available relay UE and tries to send the message. If the message size sent by the MSGin5G client 1 is more than the maximum allowed packet size of the relay UE, then the relay UE rejects the message with the clause indicating an appropriate error describing that the maximum allowed packet size for the relay UE is lower than the packet size sent by the MSGin5G client 1. Upon receiving the rejection message, the MSGin5G client 1 sets its own maximum allowed packet size to the lower value as indicated by the relay UE in the reject message, and then retries to send the message.

In an embodiment, the relay controller (110) operates as the MSGin5G client 1, and the relay controller (210) operates as the MSGin5G client 2. As another example, a controller included in MSGin5G client 1 operates as the MSGin5G client 1, and a controller included in MSGin5G client 2 operates as the MSGin5G client 2.

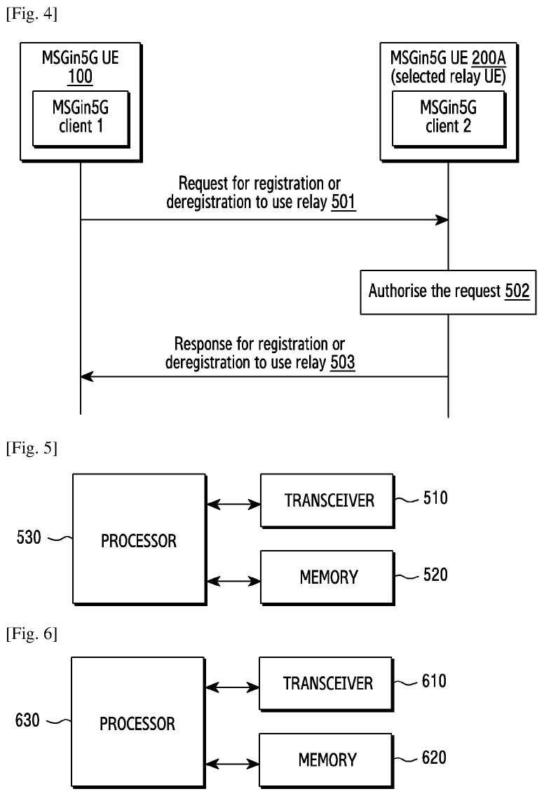

FIG. 4 is a diagram illustrating signaling of the constrained UE with the selected relay UE for registering to use relay capability of the selected relay UE according to an embodiment.

Referring to FIG. 4, the signaling flow for the MSGin5G client 1 in the MSGin5G UE (100) (which is the constrained UE) to register itself to use the relay service of the relay UE is illustrated. The same method is used by the MSGin5G client 1 in the MSGin5G UE (100) to inform the selected relay UE (200A) that the MSGin5G UE (100) (i.e. constrained UE) will use the selected MSGin5G UE (200A) as the relay UE.

Upon selecting the relay UE, the MSGin5G client 1 of the MSGin5G UE (100) sends the request message (501) (i.e. registration request message) to register with the selected relay UE and to inform the selected relay UE that the MSGin5G UE (100) (i.e. constrained UE) will use the selected UE as the relay UE. The request message may also include the other required parameters like the UE service ID and the MSGin5G UE ID of the MSGin5G UE (100) (i.e. constrained UE) and the time till when the constrained UE is intended to use the relay service from the selected relay UE (200A).

Upon receiving the request from the MSGin5G client 1 of the MSGin5G UE (100), the MSGin5G client 2 checks (502) whether the MSGin5G UE (100) is authorized to use the relay service or not. If the MSGin5G UE (100) is authorized, then the MSGin5G client 2 sends the response message (503) (i.e. registration response message) with the status of the registration to the MSGin5G UE (100). If the registration is success, the response message also includes other parameters like the accepted time till when the constrained UE (100) is allowed to use the relay service from the selected relay UE (200A).

Protocol aspects for the MSGin5G client 1 of the MSGin5G UE (100) (i.e. constrained UE): Upon receiving a request from a user to select the relay UE, the MSGin5G client generates the MSGin5G constrained device message as specified in 3GPP TS 24.538. To create the MSGin5G constrained device message, the MSGin5G client 1 sets the message type IE to “REQUEST FOR RELAY UE CONFIG”, the UE service ID IE to a UE service identifier of the constrained UE. If available in the MSGin5G constrained device message, the MSGin5G client 1 sets the MSGin5G UE ID IE to the MSGin5G UE ID of the constrained UE, the Expected packet size IE to the maximum allowed packet size of the constrained UE, and the Message ID IE to the unique identity of this message. Further, the MSGin5G client 1 sends the message as specified in 3GPP TS 24.538.

The value part of the message type information element of the MSGin5G constrained device message to request for the relay UE configuration is 00000111 in binary which is numeric 7. The name of the message to request for relay UE configuration is “REQUEST FOR RELAY UE CONFIG” or any other name.

Upon receiving the response from the relay UE with Message type IE set to “RESPONSE FOR RELAY UE CONFIG”, the MSGin5G client 1 will send the acknowledgement message with Reply-to message ID IE set to the value of the Message ID IE of the response message to the MSGin5G UE (200A).

If the constrained UE receives multiple responses from the multiple different relay UEs then the MSGin5G client 1 of the constrained UE (100) selects the relay UE whose value of the supported packet size IE is equal or more than the value of the expected packet size IE. The MSGin5G client 1 also uses the other parameters (e.g. current battery level of the relay UE, etc.) to select the relay UE. If value of the supported packet size IE is less than the value of the expected packet size IE for all relay UEs, then the MSGin5G client 1 of the constrained UE (100) selects the relay device with the maximum value of the supported packet size IE among all relay UEs and further sets the maximum allowed packet size of the constrained UE to the value of the supported packet size IE of the selected relay UE.

Upon selecting the relay UE, in order to inform the selected relay UE that the constrained UE (100) will use the selected UE as the relay UE, the constrained UE sends another MSGin5G constrained device message with the Message type ID set to “REGISTER FOR RELAY REQUEST” or any other equivalent message. The request also includes the UE service ID and MSGin5G UE ID of the constrained UE. The request also includes other required parameters like the time till when the constrained device is intended to use the relay service from the selected relay UE.

Upon receiving the response from the relay UE with the message type IE set to “REGISTER FOR RELAY RESPONSE”, the MSGin5G client 1 starts the timer with the value of accepted time till when the constrained UE (100) is allowed to use the relay service as specified in the response. The constrained UE (100) may resend the MSGin5G constrained device message with the message type ID set to “REGISTER FOR RELAY REQUEST” or any other equivalent message to continue reusing the relay service from the selected relay UE.

The value part of the message type information element of the MSGin5G constrained device message to inform the selected relay UE that the constrained UE (100) will use the selected UE as the relay UE is 00001001 in binary which is numeric 9. The name of the message, to inform the selected relay UE that the constrained UE (100) will use the selected UE as the relay UE, is “REGISTER FOR RELAY REQUEST” or any other name.

Protocol aspects for the MSGin5G client 2 of the MSGin5G UE (200A, 200B) (i.e. relay device): Upon receiving the MSGin5G constrained device message with the message type IE set to “REQUEST FOR RELAY UE CONFIG”, if the MSGin5G UE (200A) supports the relay service, then the MSGin5G client 2 in the MSGin5G UE (200A) generates the MSGin5G constrained device message according to clause 8.1.2. The MSGin5G client 2 in the MSGin5G UE (200A) creates the MSGin5G constrained device message by setting the message type IE to “RESPONSE FOR RELAY UE CONFIG”, the UE Service ID IE to the UE service identifier of the relay UE. If available, the MSGin5G client 2 in the MSGin5G UE (200A) creates the MSGin5G constrained device message by setting the message the MSGin5G UE ID IE to the MSGin5G UE ID of the relay UE, the supported packet size IE to the maximum allowed packet size of the relay UE, the replay-to message ID IE to the value of the Message ID IE of the received request message, and the message ID IE to the unique identity of this response message. Further, the MSGin5G client 2 in the MSGin5G UE (200A) sends the message as specified in 3GPP TS 24.538.

The value part of the message type information element of the MSGin5G constrained device message to response for the relay UE configuration is 00001000 in binary which is numeric 8. The name of the message to response for the relay UE configuration is “RESPONSE FOR RELAY UE CONFIG” or any other name.

Upon receiving the MSGin5G constrained device message with the message type IE set to “REGISTER FOR RELAY REQUEST”, the MSGin5G client in the relay UE authorizes the constrained UE (100) to use the MSGin5G UE (200A) as the relay UE. The MSGin5G client 2 in the relay UE (200A) sends the response the MSGin5G constrained device message with the message type IE set to “REGISTER FOR RELAY RESPONSE”. The response also includes other required parameters like the accepted time till when the constrained UE (100) is allowed to use the relay service from the selected relay UE. The value part of the message type information element of the MSGin5G constrained device message, to response to the constrained UE (100) to use the relay service from the selected relay UE, is 00001010 in binary which is numeric 10. The name of the message, to response to the constrained UE (100) to use the relay service from the selected relay UE, is “REGISTER FOR RELAY RESPONSE” or any other name.

In an embodiment, the relay controller (110) operates as the MSGin5G client 1, and the relay controller (210) operates as the MSGin5G client 2. As another example, a controller included in MSGin5G client 1 operates as the MSGin5G client 1, and a controller included in MSGin5G client 2 operates as the MSGin5G client 2.

FIG. 5 illustrates a structure of a UE according to an embodiment of the disclosure.

As shown in FIG. 5, the UE according to an embodiment may include a transceiver 510, a memory 520, and a processor 530. The transceiver 510, the memory 520, and the processor 530 of the UE may operate according to a communication method of the UE described above. However, the components of the UE are not limited thereto. For example, the UE may include more or fewer components than those described above. In addition, the processor 530, the transceiver 510, and the memory 520 may be implemented as a single chip. Also, the processor 530 may include at least one processor. Furthermore, the UE of FIG. 5 corresponds to the constrained UE 100 of the FIG. 1 and/or the UE of FIG. 5 corresponds to the UE 200 of the FIG. 1.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for upconverting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE. Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 may receive a data signal including a control signal transmitted by the base station or the network entity, and the processor 530 may determine a result of receiving the control signal and the data signal transmitted by the base station or the network entity.

FIG. 6 illustrates a structure of a base station according to an embodiment of the disclosure.

As shown in FIG. 6, the base station according to an embodiment may include a transceiver 610, a memory 620, and a processor 630. The transceiver 610, the memory 620, and the processor 630 of the base station may operate according to a communication method of the base station described above. However, the components of the base station are not limited thereto. For example, the base station may include more or fewer components than those described above. In addition, the processor 630, the transceiver 610, and the memory 620 may be implemented as a single chip. Also, the processor 630 may include at least one processor. For example, the base station of FIG. 6 corresponds to MSGin5G server of the FIG. 1 through FIG. 6.

The transceiver 610 collectively refers to a base station receiver and a base station transmitter, and may transmit/receive a signal to/from a terminal (UE) or a network entity. The signal transmitted or received to or from the terminal or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the base station. Also, the memory 620 may store control information or data included in a signal obtained by the base station. The memory 620 may be a storage medium, such as read-only memory (ROM), random access memory (RAM), a hard disk, a CD-ROM, and a DVD, or a combination of storage media.

The processor 630 may control a series of processes such that the base station operates as described above. For example, the transceiver 610 may receive a data signal including a control signal transmitted by the terminal, and the processor 630 may determine a result of receiving the control signal and the data signal transmitted by the terminal.

According to an embodiment, a method for determining a relay User Equipment (UE) for a constrained UE (100) is provided. The method comprises sending, by the constrained UE (100), a relay configuration request message to a plurality of UEs, receiving, by the constrained UE (100), a relay configuration response message from at least one UE (200) supporting a relay service e, determining, by the constrained UE (100), a maximum allowed packet size of the at least one UE (200) based on the relay configuration response message and determining, by the constrained UE (100), the relay UE in the at least one UE (200) for using the relay service of the relay UE based on the maximum allowed packet size of the at least one UE (200).

The relay configuration request message comprises a Layer-2 identity, a UE service identifier, a MSGin5G device identifier, and a maximum allowed packet size of the constrained UE (100). The relay configuration response message comprises a Layer-2 identity, a UE service identifier, a MSGin5G device identifier, and a maximum allowed packet size of the at least one UE (200).

The determining, by the constrained UE (100), the relay UE in the at least one UE (200) for using the relay service of the relay UE based on the maximum allowed packet size of the at least one UE (200), comprises determining, by the constrained UE (100), whether the maximum allowed packet size of the at least one UE (200) is equal or more than a maximum allowed packet size of the constrained UE (100), performing, by the constrained UE (100), at least one of selecting the relay UE in the at least one UE (200) with the maximum allowed packet size of the relay UE is equal or more than the maximum allowed packet size of the constrained UE (100), when the maximum allowed packet size of the at least one UE (200) is equal or more than the maximum allowed packet size of the constrained UE (100), and selecting the relay UE in the at least one UE (200) with a largest maximum allowed packet size, modifying the maximum allowed packet size of the constrained UE (100) to the largest maximum allowed packet size of the selected relay UE, when the maximum allowed packet size of the at least one UE (200) is less than the maximum allowed packet size of the constrained UE (100).

The method comprises sending, by the constrained UE (100), a registration request message to the relay UE to register for consuming the relay service of the relay UE, receiving, by the constrained UE (100), a registration response message with a status of registration of the constrained UE (100) from the relay UE and determining, by the constrained UE (100), whether the constrained UE (100) is registered at the relay UE based on the status of registration.

The registration request message comprises a UE service identifier, and a MSGin5G UE ID of the constrained UE (100), and a time till the constrained UE (100) is intended to use the relay service from the relay UE. The registration response message comprises a time till the constrained UE (100) is allowed to use the relay service from the relay UE.

According to an embodiment, a method for determining a relay User Equipment (UE) for a constrained UE (100) is provided. The method comprises receiving, by a UE (200), a relay configuration request message from the constrained UE (100), determining, by the UE (200), whether the UE has a capability to provide a relay service to the constrained UE (100) and sending, by the UE (200), a relay configuration response message to the constrained UE (100).

The relay configuration request message comprises a Layer-2 identity, a UE service identifier, a MSGin5G device identifier, and a maximum allowed packet size of the constrained UE (100). The relay configuration response message comprises a Layer-2 identity, a UE service identifier, a MSGin5G device identifier, and a maximum allowed packet size of the UE (200).

The method further comprises receiving, by the UE (200), a registration request message from the constrained UE (100), determining, by the UE (200), whether the constrained UE (100) is authorized to consume the relay service, sending, by the UE (200), a registration response message with a status of registration of the constrained UE (100) to the constrained UE (100).

The registration request message comprises a UE service identifier, and a MSGin5G UE ID of the constrained UE (100), and a time till the constrained UE (100) is intended to use the relay service from the UE (200). The registration response message comprises a time till the constrained UE (100) is allowed to use the relay service from the UE (200).

According to an embodiment, a constrained User Equipment (UE) (100) for determining a relay UE is provided. The UE comprises a memory (120), a processor (130) and a relay controller (110), coupled to the memory (120). The processor (130) is configured to send a relay configuration request message to a plurality of UEs, receive a relay configuration response message from at least one UE (200) supporting a relay service in the plurality of UEs, determine a maximum allowed packet size of the at least one UE (200) based on the relay configuration response message, and determine the relay UE in the at least one UE (200) for using the relay service of the relay UE based on the maximum allowed packet size of the at least one UE (200).

According to an embodiment, a User Equipment (UE) (200) for determining a relay UE for a constrained UE (100) is provided. The UE comprises a memory (220), a processor (230) and a relay controller (210), coupled to the memory (220). The processor (230) is configured to receive a relay configuration request message from the constrained UE (100), determine whether the UE has a capability to provide a relay service to the constrained UE (100), and send a relay configuration response message to the constrained UE (100).

According to an embodiment, a method is provided. The method comprises e receiving, from at least one UE with a relay capability among the plurality of UEs, a second message as a response to the first message, the second message comprising information on the relay configuration, and e

The first message comprises at least one of a layer-2 identity (ID) of the first UE, a UE service ID of the first UE, a device ID of the first UE, or a maximum allowed packet size of the first UE, and the second message comprises at least one of a layer-2 identity (ID) of the second UE, a UE service ID of the second UE, a device ID of the second UE, or the maximum allowed packet size of the second UEe

The identifying of the second UE for the relay service comprises in case that at least one of values of maximum allowed packet sizes of the at least one UE with the relay capability is equal or more than a value of the maximum allowed packet size of the first UE, identifying a UE supporting a maximum allowed packet size equal or more than the maximum allowed packet size of the first UE as the second UE for the relay service, and in case that the values of the maximum allowed packet sizes of the at least one UE with the relay capability are less than the value of the maximum allowed packet size of the first UE, identifying a UE supporting a maximum allowed packet size having a maximum value among the values of maximum allowed packet sizes of the at least one UE with the relay capability as the second UE for the relay service, and the method further comprises setting the value of the maximum allowed packet size of the first UE to a value of the maximum allowed packet size of the second UE for the relay service.

The method comprises transmitting, to the second UE for the relay service, a third message for requesting a registration and indicating that the second UE for the relay service is used for the relay service of the first UE, in case that the first UE is authorized for the registration, receiving, from the second UE for the relay service, a fourth message as a response to the third message, the fourth message comprising information for a status of the registration. The third message comprises at least one of a UE service identity (ID) of the first UE, a device ID of the first UE or information for time in which the first UE is intended to use the relay service from the second UE, and in case that the registration is successful, the fourth message comprises information for time in which the first UE is allowed to use the relay service from the second UE.

According to an embodiment, a first user equipment (UE) which is a constrained UE in a wireless communication system is provided. The first UE comprises a transceiver and a controller coupled with the transceiver and configured to transmit, to a plurality of UEs, a first message for requesting a relay configuration for the first UE, receive, from at least one UE with a relay capability among the plurality of UEs, a second message as a response to the first message, the second message comprising information on the relay configuration, and identify a second UE for a relay service among the at least one UE with the relay capability based on the information on a maximum allowed packet size of the second UE.

The first message comprises at least one of a layer-2 identity (ID) of the first UE, a UE service ID of the first UE, a device ID of the first UE, or a maximum allowed packet size of the first UE, and the second message comprises at least one of a layer-2 identity (ID) of the second UE, a UE service ID of the second UE, a device ID of the second UE, or the maximum allowed packet size of the second UE.

The controller is further configured to in case that at least one of values of maximum allowed packet sizes of the at least one UE with the relay capability is equal or more than a value of the maximum allowed packet size of the first UE, identify a UE supporting a maximum allowed packet size equal or more than the maximum allowed packet size of the first UE as the second UE for the relay service, in case that the values of the maximum allowed packet sizes of the at least one UE with the relay capability are less than the value of the maximum allowed packet size of the first UE, identify a UE supporting a maximum allowed packet size having a maximum value among the values of maximum allowed packet sizes of the at least one UE with the relay capability as the second UE for the relay service, and set the value of the maximum allowed packet size of the first UE to a value of the maximum allowed packet size of the second UE for the relay service.

The controller is further configured to transmit, to the second UE for the relay service, a third message for requesting a registration and indicating that the second UE for the relay service is used for the relay service of the first UE, in case that the first UE is authorized for the registration, receive, from the second UE for the relay service, a fourth message as a response to the third message, the fourth message comprising information for a status of the registration. The third message comprises at least one of a UE service identity (ID) of the first UE, a device ID of the first UE or information for time in which the first UE is intended to use the relay service from the second UE, and in case that the registration is successful, the fourth message comprises information for time in which the first UE is allowed to use the relay service from the second UE.

According to an embodiment, a method performed by a second user equipment (UE) with a relay capability in a wireless communication system is provided. The method comprises receiving, from a first UE which is a constrained UE, a first message for requesting a relay configuration for the first UE, and transmitting, to the first UE, a second message as a response to the first message, the second message comprising information on the relay configuration. The second UE with the relay capability is used for a relay service based on the information on a maximum allowed packet size of the second UE comprised in the second message.

The first message comprises at least one of a layer-2 identity (ID) of the first UE, a UE service ID of the first UE, a device ID of the first UE, or a maximum allowed packet size of the first UE. The second message comprises at least one of a layer-2 identity (ID) of the second UE, a UE service ID of the second UE, a device ID of the second UE, or the maximum allowed packet size of the second UE.

The method comprises receiving, from the first UE, a third message for requesting a registration and indicating that the second UE for the relay service is used for the relay service of the first UE, determining whether the first UE is authorized to use the relay service of the first UE, and in case that the first UE is authorized for the registration, transmitting, to the first UE, a fourth message as a response to the third message, the fourth message comprising information for a status of the registration. The third message comprises at least one of a UE service identity (ID) of the first UE, a device ID of the first UE or information for time in which the first UE is intended to use the relay service from the second UE. In case that the registration is successful, the fourth message comprises information for time in which the first UE is allowed to use the relay service from the second UE.

According to an embodiment, a second user equipment (UE) with a relay capability in a wireless communication system is provided. The second UE comprises a transceiver and a controller coupled with the transceiver and configured to receive, from a first UE which is a constrained UE, a first message for requesting a relay configuration for the first UE, and transmit, to the first UE, a second message as a response to the first message, the second message comprising information on the relay configuration. The second UE with the relay capability is used for a relay service based on the information on a maximum allowed packet size of the second UE comprised in the second message.

The first message comprises at least one of a layer-2 identity (ID) of the first UE, a UE service ID of the first UE, a device ID of the first UE, or a maximum allowed packet size of the first UE. The second message comprises at least one of a layer-2 identity (ID) of the second UE, a UE service ID of the second UE, a device ID of the second UE, or the maximum allowed packet size of the second UE.

A value of the maximum allowed packet size of the first UE is set to a value of the maximum allowed packet size of the second UE for the relay service.

The controller is further configured to receive, from the first UE, a third message for requesting a registration and indicating that the second UE for the relay service is used for the relay service of the first UE, determine whether the first UE is authorized to use the relay service of the first UE, and in case that the first UE is authorized for the registration, transmitting, to the first UE, a fourth message as a response to the third message, the fourth message comprising information for a status of the registration. The third message comprises at least one of a UE service identity (ID) of the first UE, a device ID of the first UE or information for time in which the first UE is intended to use the relay service from the second UE. In case that the registration is successful, the fourth message comprises information for time in which the first UE is allowed to use the relay service from the second UE.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a first user equipment (UE) which is a constrained UE in a wireless communication system, the method comprising:
transmitting, to a plurality of UEs, a first message for requesting a relay configuration for the first UE,
receiving, from at least one UE with a relay capability among the plurality of UEs, a second message as a response to the first message,
the second message comprising information on the relay configuration, and
identifying a second UE for a relay service among the at least one UE with the relay capability based on the information on a maximum allowed packet size of the second UE.

2. The method of claim 1, wherein the first message comprises at least one of a layer-2 identity (ID) of the first UE, a UE service ID of the first UE, a device ID of the first UE, or a maximum allowed packet size of the first UE, and
wherein the second message comprises at least one of a layer-2 identity (ID) of the second UE, a UE service ID of the second UE, a device ID of the second UE, or the maximum allowed packet size of the second UE.

3. The method of claim 2, wherein the identifying of the second UE for the relay service comprises:
in case that at least one of values of maximum allowed packet sizes of the at least one UE with the relay capability is equal or more than a value of the maximum allowed packet size of the first UE, identifying a UE supporting a maximum allowed packet size equal or more than the maximum allowed packet size of the first UE as the second UE for the relay service, and
in case that the values of the maximum allowed packet sizes of the at least one UE with the relay capability are less than the value of the maximum allowed packet size of the first UE, identifying a UE supporting a maximum allowed packet size having a maximum value among the values of maximum allowed packet sizes of the at least one UE with the relay capability as the second UE for the relay service, and
wherein the method further comprises setting the value of the maximum allowed packet size of the first UE to a value of the maximum allowed packet size of the second UE for the relay service.

4. The method of claim 1, further comprising:
transmitting, to the second UE for the relay service, a third message for requesting a registration and indicating that the second UE for the relay service is used for the relay service of the first UE,
in case that the first UE is authorized for the registration, receiving, from the second UE for the relay service, a fourth message as a response to the third message, the fourth message comprising information for a status of the registration,
wherein the third message comprises at least one of a UE service identity (ID) of the first UE, a device ID of the first UE or information for time in which the first UE is intended to use the relay service from the second UE, and
wherein, in case that the registration is successful, the fourth message comprises information for time in which the first UE is allowed to use the relay service from the second UE.

5. A first user equipment (UE) which is a constrained UE in a wireless communication system, the first UE comprising:
a transceiver; and
a controller coupled with the transceiver and configured to:
transmit, to a plurality of UEs, a first message for requesting a relay configuration for the first UE,
receive, from at least one UE with a relay capability among the plurality of UEs, a second message as a response to the first message,
the second message comprising information on the relay configuration, and
identify a second UE for a relay service among the at least one UE with the relay capability based on the information on a maximum allowed packet size of the second UE.

6. The first UE of claim 5, wherein the first message comprises at least one of a layer-2 identity (ID) of the first UE, a UE service ID of the first UE, a device ID of the first UE, or a maximum allowed packet size of the first UE, and
wherein the second message comprises at least one of a layer-2 identity (ID) of the second UE, a UE service ID of the second UE, a device ID of the second UE, or the maximum allowed packet size of the second UE.

7. The first UE of claim 6, wherein the controller is further configured to:
in case that at least one of values of maximum allowed packet sizes of the at least one UE with the relay capability is equal or more than a value of the maximum allowed packet size of the first UE, identify a UE supporting a maximum allowed packet size equal or more than the maximum allowed packet size of the first UE as the second UE for the relay service,
in case that the values of the maximum allowed packet sizes of the at least one UE with the relay capability are less than the value of the maximum allowed packet size of the first UE, identify a UE supporting a maximum allowed packet size having a maximum value among the values of maximum allowed packet sizes of the at least one UE with the relay capability as the second UE for the relay service, and
set the value of the maximum allowed packet size of the first UE to a value of the maximum allowed packet size of the second UE for the relay service.

8. The first UE of claim 5, wherein the controller is further configured to:
transmit, to the second UE for the relay service, a third message for requesting a registration and indicating that the second UE for the relay service is used for the relay service of the first UE,
in case that the first UE is authorized for the registration, receive, from the second UE for the relay service, a fourth message as a response to the third message, the fourth message comprising information for a status of the registration,
wherein the third message comprises at least one of a UE service identity (ID) of the first UE, a device ID of the first UE or information for time in which the first UE is intended to use the relay service from the second UE, and
wherein, in case that the registration is successful, the fourth message comprises information for time in which the first UE is allowed to use the relay service from the second UE.

9. A method performed by a second user equipment (UE) with a relay capability in a wireless communication system, the method comprising:
receiving, from a first UE which is a constrained UE, a first message for requesting a relay configuration for the first UE, and
transmitting, to the first UE, a second message as a response to the first message, the second message comprising information on the relay configuration,
wherein the second UE with the relay capability is used for a relay service based on the information on a maximum allowed packet size of the second UE comprised in the second message.

10. The method of claim 9, wherein the first message comprises at least one of a layer-2 identity (ID) of the first UE, a UE service ID of the first UE, a device ID of the first UE, or a maximum allowed packet size of the first UE, and
wherein the second message comprises at least one of a layer-2 identity (ID) of the second UE, a UE service ID of the second UE, a device ID of the second UE, or the maximum allowed packet size of the second UE.

11. The method of claim 9, further comprising:
receiving, from the first UE, a third message for requesting a registration and indicating that the second UE for the relay service is used for the relay service of the first UE,
determining whether the first UE is authorized to use the relay service of the first UE, and
in case that the first UE is authorized for the registration, transmitting, to the first UE, a fourth message as a response to the third message, the fourth message comprising information for a status of the registration,
wherein the third message comprises at least one of a UE service identity (ID) of the first UE, a device ID of the first UE or information for time in which the first UE is intended to use the relay service from the second UE, and
wherein, in case that the registration is successful, the fourth message comprises information for time in which the first UE is allowed to use the relay service from the second UE.

12. A second user equipment (UE) with a relay capability in a wireless communication system, the second UE comprising:
a transceiver; and
a controller coupled with the transceiver and configured to:
receive, from a first UE which is a constrained UE, a first message for requesting a relay configuration for the first UE, and
transmit, to the first UE, a second message as a response to the first message, the second message comprising information on the relay configuration,
wherein the second UE with the relay capability is used for a relay service based on the information on a maximum allowed packet size of the second UE comprised in the second message.

13. The second UE of claim 12, wherein the first message comprises at least one of a layer-2 identity (ID) of the first UE, a UE service ID of the first UE, a device ID of the first UE, or a maximum allowed packet size of the first UE, and
wherein the second message comprises at least one of a layer-2 identity (ID) of the second UE, a UE service ID of the second UE, a device ID of the second UE, or the maximum allowed packet size of the second UE.

14. The second UE of claim 13, wherein a value of the maximum allowed packet size of the first UE is set to a value of the maximum allowed packet size of the second UE for the relay service.

15. The second UE of claim 12, wherein the controller is further configured to:
receive, from the first UE, a third message for requesting a registration and indicating that the second UE for the relay service is used for the relay service of the first UE,
determine whether the first UE is authorized to use the relay service of the first UE, and
in case that the first UE is authorized for the registration, transmitting, to the first UE, a fourth message as a response to the third message, the fourth message comprising information for a status of the registration,
wherein the third message comprises at least one of a UE service identity (ID) of the first UE, a device ID of the first UE or information for time in which the first UE is intended to use the relay service from the second UE, and
wherein, in case that the registration is successful, the fourth message comprises information for time in which the first UE is allowed to use the relay service from the second UE.
